(19) United States
(12) Patent Application Publication
(10) Pub. No.: US 2009/0296332 A1
(43) Pub. Date: Dec. 3, 2009

(54) Flat-Screen Display System With Corresponding Sleeves

(75) Inventor: Jean-Michel Policar, Paris (FR)

Correspondence Address: Thomson Licensing LLC, P.O. Box 5312, Two Independence Way, PRINCETON, NJ, 08543-5312, US

(73) Assignee: THOMSON LICENSING, Boulogne Billancout (FR)

(21) Appl. No.: 11/988,406

(22) PCT Filed: Jul. 5, 2006
(86) PCT No.: PCT/FR2006/050681

§ 371 Date: Aug. 4, 2009

(30) Foreign Application Priority Data
Jul. 7, 2005 (FR) 0552097
Sep. 2, 2005 (FR) 0552660

(51) Int. Cl. G06F 1/16; F16M 11/04

(52) U.S. Cl. 361/679.21; 248/176.1

(57) ABSTRACT

The invention concerns a display system comprising a flat-screen display device and a support for the said display device. The support forms a removable sleeve designed to hold the display device.

### SCOPE OF THE INVENTION

The invention relates to the field of display systems and more specifically to the positioning of flat-screen display devices on a plane, for example of the liquid crystal type or LCD (Liquid Crystal Display).

### PRIOR ART

According to the prior art, flat screens can be mounted on a wall or set on a plane. Such a screen is, for example, described in patent application US2004/0084588.

The transfer from a set down position to a hanging position generally requires a complex operation, especially when installing and/or removing a support attached to the back of the screen. This operation presents the disadvantage of being relatively cumbersome to carry out and requires a complicated support.

### SUMMARY OF THE INVENTION

The purpose of the invention is to overcome the disadvantages of the prior art.

More particularly, the invention has the goal of improving the flexibility of use and/or the ergonomics of a flat-screen display system so that it may be easily set down or mounted on a wall.

The invention relates to a display system comprising a flat-screen display device and a support for the display device, remarkable in that the support forms a removable stand designed to hold the display device.

Advantageously, the stand comprises a base designed to hold the screen in a noticeably vertical position when the system is set on a noticeably horizontal plane and/or mounted on a noticeably vertical plane.

Preferentially, the stand comprises noticeably vertical walls in its hollow part when the system is set on a noticeably horizontal plane, and the display device is inserted between the walls.

According to a particular characteristic, the stand comprises noticeably vertical outer walls.

According to another particular characteristic, the stand comprises a base with a lower surface and an upper surface, the upper surface being noticeably parallel to the lower surface.

According to a preferred characteristic, the display device comprises recesses in its lower part, which is designed to be inserted into the stand.

Advantageously, the base is ballasted.

Advantageously, the outer walls of the stand and the display device are contiguous and, even more advantageously, tangent.

The invention also relates to the corresponding stand.

### LIST OF FIGURES

The invention will be better understood, and other specific features and advantages will emerge from reading the following description, the description making reference to the annexed drawings wherein:

FIG. 1 illustrates a front view of a display system set on a plane according to a preferred embodiment of the invention,

FIG. 2 presents a back view of the system in FIG. 1,

FIGS. 3 and 4 present, respectively, a back view or a front view of the system in FIG. 1 from an oblique angle,

FIG. 5 is a front view of the display system in FIG. 1, the screen being hung on a wall,

FIGS. 6 to 9 and 12 to 17 present variants of the invention, according to particular embodiments, and

FIGS. 10 and 11 illustrate a side view of the display system in FIG. 1.

### DETAILED DESCRIPTION OF THE INVENTION

The general principle of this invention is therefore based upon a display system comprising a removable stand. Hence, when the system goes from a hanging position to being set on a horizontal plane, the user can easily insert the display device into the stand, which ensures the stability of the screen. Conversely, when the system goes from being set on a horizontal plane to a hanging or suspended position, the user can easily remove the display device from its stand and hang it. This architecture provides the user with flexibility in terms of choice of installation.

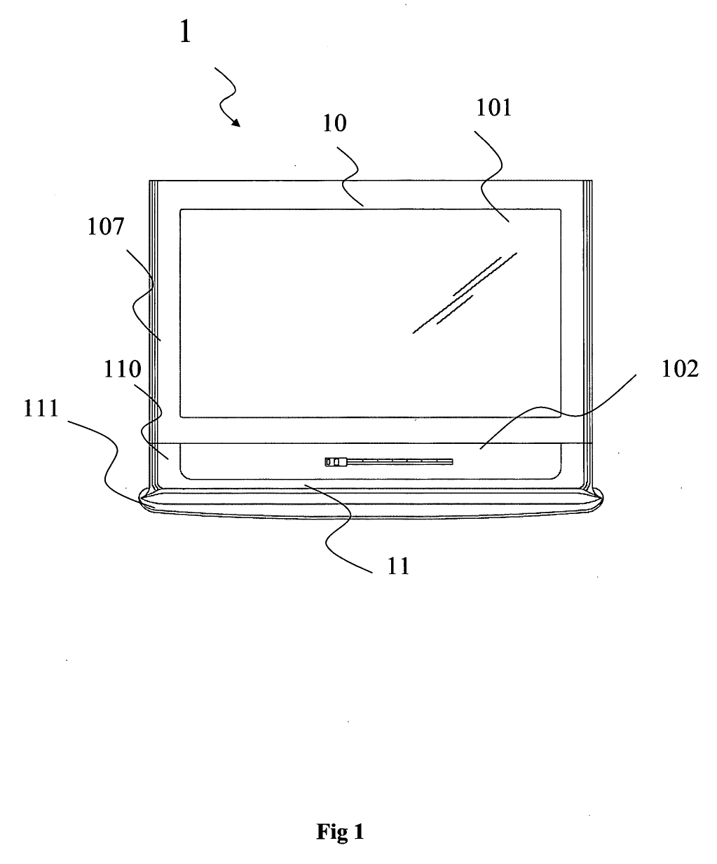

FIG. 1 diagrammatically illustrates a front view of display system 1 set on a horizontal plane according to a preferred embodiment of the invention.

The display system 1 comprises:
a display device 10 comprising a flat screen 101, a casing 107 and one or more loudspeakers 102 on the front, and
a hollow stand 11 designed to accommodate a display device.

The flat screen 101 is, for example, an LCD screen or a plasma-type screen.

The loudspeaker or loudspeakers 102 are positioned below the screen.

The display device 10 is inserted in stand 11, which maintains the display device in a noticeably vertical position (that is with a screen whose front plane makes an angle less than or equal to 11° with the vertical), and more generally in a position of comfort, allowing a spectator located opposite the screen to have a good view.

The stand comprises a base 111 and walls 110. The base 111 comprises a noticeably flat lower surface designed to sit on a noticeably horizontal floor (meaning that it makes an angle less than or equal to 11° with a horizontal plane), and an upper surface that is noticeably parallel to the lower surface (meaning that the two surfaces form, at least partially, planes that make an angle less than or equal to 11° with each other). The inner and outer faces of the walls 110 are noticeably vertical, the walls 110 forming a hollow space and being designed to hold the display device when it is inserted into the stand.

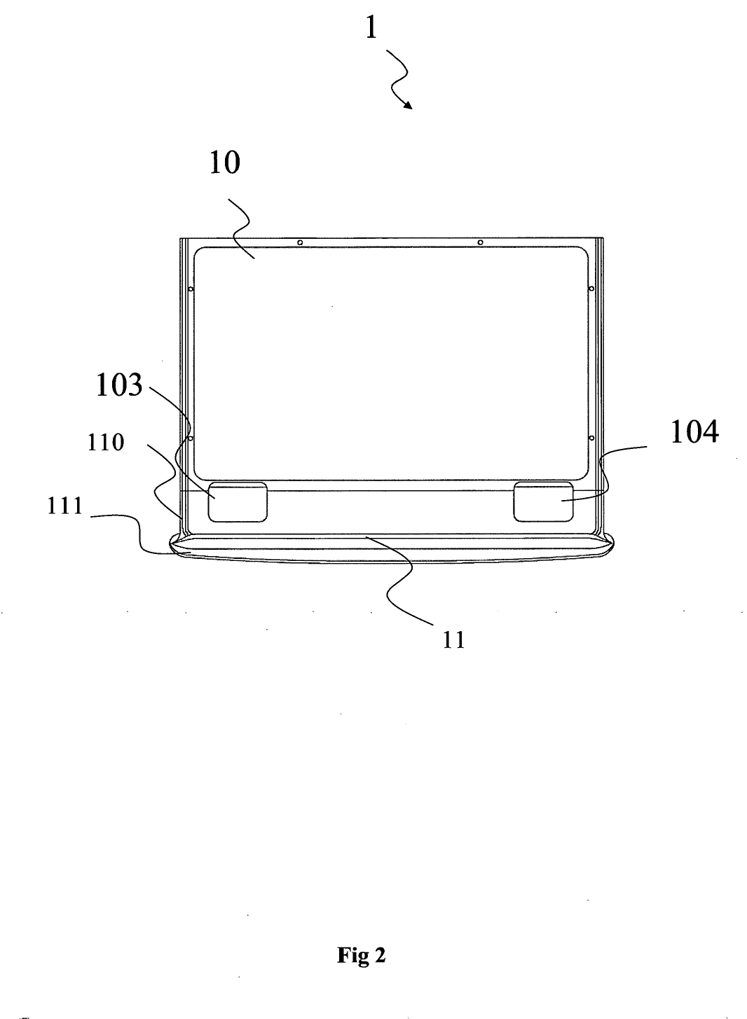

FIG. 2 presents a back view of screen 1 and illustrates, notably, back parts 103 and 104, associated with the display device 10, which notably comprise connectors designed to connect device 10 to an electric power supply and/or to audio/video inputs/outputs.

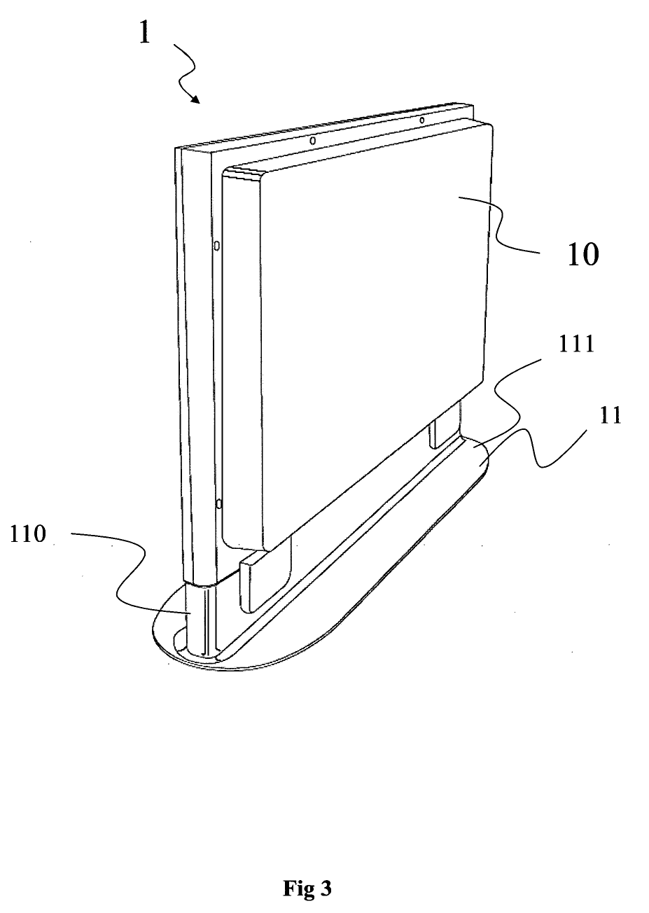

FIGS. 3 and 4 illustrate the display device 1 from a three-quarter view, back and front respectively, emphasizing the base 111 of the stand 11.

The width of the base 111 sifting on the floor is, for example, equal to 170 mm for a screen 101 having a 26″ diagonal. More generally, the parts of the base 111 that are respectively located in front of and behind the walls 110 each have a depth preferentially greater than 4 cm and even more preferentially greater than 6 cm. Hence, the stability of the display device 10 is ensured when it is set on a noticeably horizontal plane.

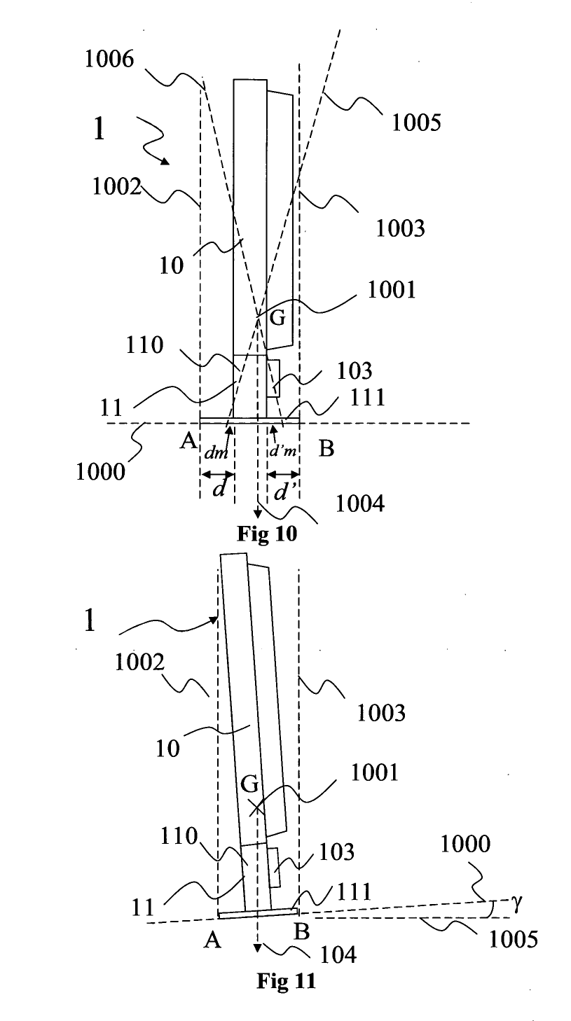

FIGS. 10 and 11 illustrate display system 1, viewed from the side, sifting on plane 1000 respectively horizontal and inclined at angle γ in relation to a horizontal plane.

Preferentially, device 1 remains stable when the display device 1 is sitting on a noticeably horizontal plane and has an angle of inclination less than or equal to 11° (γ is less than or equal to 11°) forward or backward from the device 1.

In other words, depths d and d′ of the parts of base 111, respectively located in front of and behind the walls 110 and sitting on the floor, are such that the centre of gravity, G, 1001 of device 1, is preferentially between two vertical planes 1002 and 1003 that respectively pass through extremities A and B, corresponding to the front and rear edges of base 111 when the device 1 is sitting on a noticeably horizontal plane and has an angle of inclination less than or equal to 11° forward or backward from the device 1. Generally, the planes 1005 and 1006, which pass through centre of gravity G and correspond respectively to vertical planes when the angle of inclination of the floor in relation to the horizontal is maximal (or 11°, preferentially), define minimum values dm and d′m of depths d and d′ (the part of the base 111 that sits on the floor must spread beyond the planes 1005 and 1006).

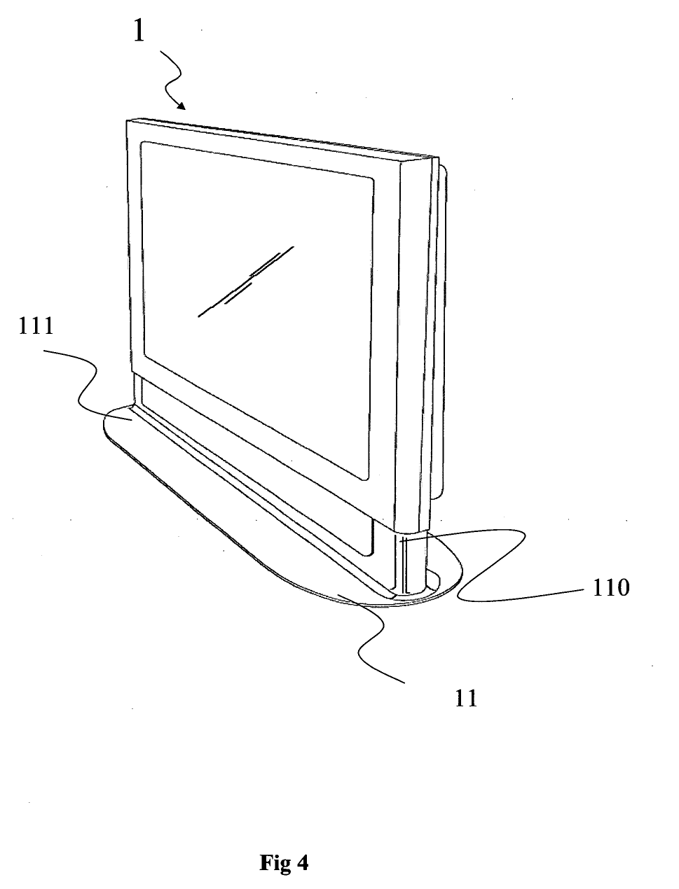

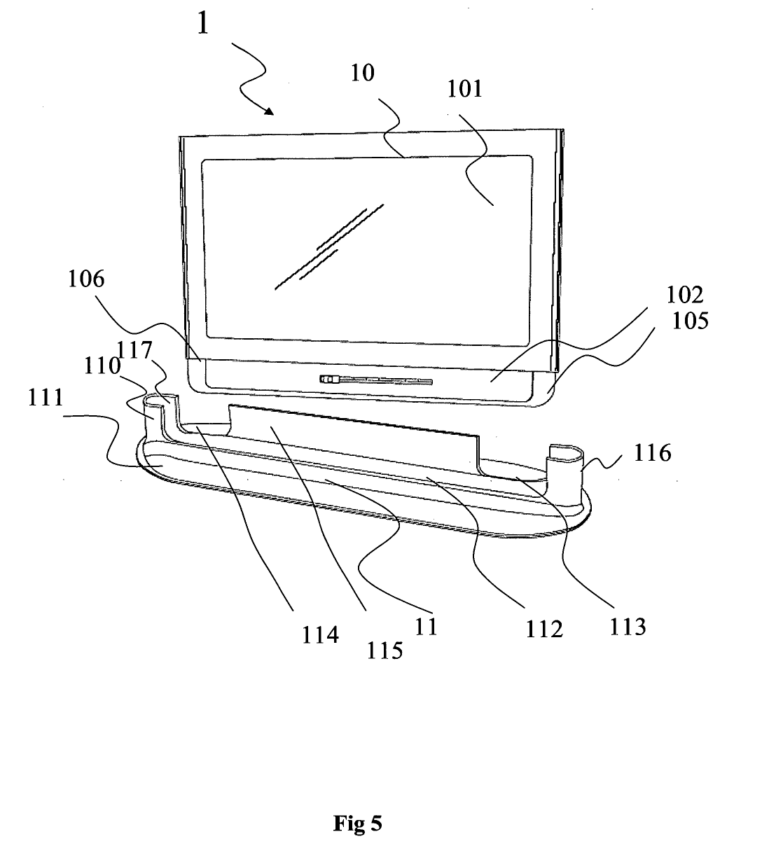

FIG. 5 presents a view of the display system 1 when the removable screen 10 is separated from the stand 11.

The walls 110 comprise:
a cut-out 112 on the front allowing the loud speaker or loudspeakers 102 to be inserted,
cut-outs 113 and 114 on the back face allowing the back parts 103 and 104 respectively to be inserted, and
side and front supports 116 and 117 and a back support 115 allowing screen 10 to be held in place.

The cut-outs 112 to 114 have a shape suited to the part of device 10 that they hold. The walls are noticeably vertical in the hollow part of the stand when the system is set on a noticeably horizontal plane, and the display device fits inside the walls. Preferentially, they are precisely contoured to this shape (the dimensions of each cut-out are noticeably equal to those of the element they hold). Preferentially, the cut-outs and the corresponding elements they hold are shaped in such a way that these elements can easily be inserted (for example, vertical sides and/or width of each cut-out or of each corresponding element tapering downward). Preferentially, the outer surfaces of the walls 110 and of the display device 10 are contiguous; in other words, the casing of the display device 10 comprises recesses 105 and 106, whose depth is preferentially greater than or equal to (and even more preferentially, equal to) the thickness of walls 110, such that walls 110 are flush with the outer surface of the casing of device 10. Hence, the outer surface of the walls 110 and the outer surface of the device 10 are contiguous and tangent and, as a result, there is no unevenness between the casing and walls 110, which notably provides for a more attractive system that is less cumbersome.

The stand is preferentially made of plastic and is, for example, obtained by one-piece plastic injection. Hence, the support is relatively inexpensive and simple to produce. In addition, the invention has a customization potential through the diversity of colors and finishes.

According to one variant of the invention, the display device does not have recesses 105 and 106 and the stand simply comprises the cut-outs necessary for the display device parts that need room in the stand (loudspeakers, inputs/outputs, displays, remote control sensors, power supply). In this case, preferentially, the walls of the stand are thin (typically less than or equal to 3 mm), which limits unevenness between the stand and the display device when the latter is sitting on a horizontal plane.

According to one variant embodiment of the invention, the base 111 is ballasted (and comprises, for example, a filled metal part), which improves the stability of system 1 and reduces the cumbersomeness of the stand 11.

According to another variant embodiment of the invention, the stand comprises additional means for attaching the display device to the stand for improved stability. Hence, according to this variant, the vertical walls are, for example, fitted with screws designed to be screwed into device 10 (which comprises a female screw section) or fitted with clips that can snap onto the device 10 (which therefore comprises a recessed part that the clip notches fit into). Preferentially, these additional attachment means are located on the back of the stand.

Generally, the number of plastic parts is limited (for example, equal to one) and the attachment between the stand and the display device is limited (for example, equal to one, two, or three) and preferentially null.

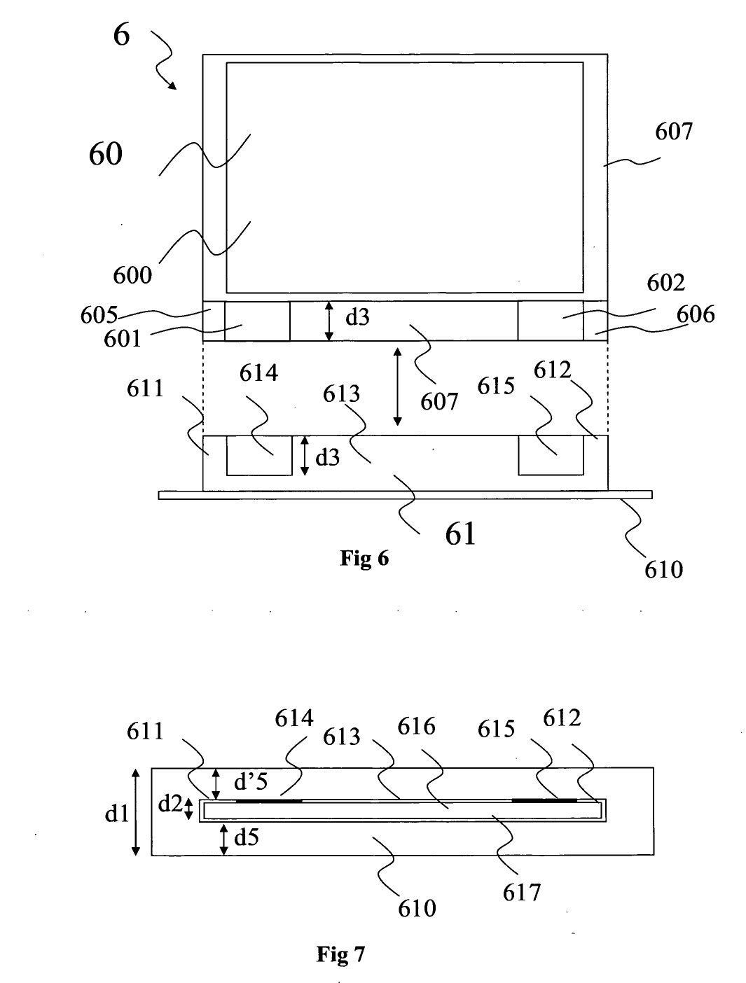

FIGS. 6 and 7 illustrate diagrammatically a front view and a top view of display system 6 according to a variant embodiment of the invention.

The front of the display system 6 comprises:
a display device 60 comprising a flat screen 600, a casing 607 and two loudspeakers 601 and 602, and
a hollow stand 61 designed to accommodate the display device 60.

The flat screen 60 is, for example, an LCD screen or a plasma-type screen.

The loudspeakers 601 and 602 are positioned below the screen, at the sides.

When it is sitting on a noticeably horizontal plane, the display device 60 is inserted in stand 61, which maintains the display device in a noticeably vertical position, and more generally in a position of comfort, allowing a spectator located opposite the screen to have a good view.

Stand 61 comprises a noticeably horizontal base 610 designed to sit on a noticeably horizontal floor, and noticeably vertical walls 611 designed to hold the display device when it is inserted in the stand.

The walls 611 comprise:
two cut-outs 614 and 615 on the front that allow loudspeakers 601 and 602 to be inserted,
cut-outs on the back face that allow the rear parts of the display device to be inserted (power supply, inputs/outputs), and
side and front supports 611 and 613 and back support 617 allowing the screen 60 to be held in place.

The cut-outs 614 to 615 are specifically shaped for the device 60 that they hold. Preferentially, they are precisely contoured to this shape (the dimensions of each cut-out are noticeably equal to those of the element they hold). Preferentially, the cut-outs and the corresponding elements they hold are shaped in such a way that these elements can easily be inserted (for example, vertical sides and/or width of each cut-out or of each corresponding element tapering downward). Preferentially, the outer surfaces of the walls 611 and of the display device 60 are contiguous and, advantageously, tangent; in other words, the casing of display device 60 comprises recesses 605 to 607, whose depth is preferentially greater than or equal to (and even more preferentially, equal to) the thickness of the walls 611, such that the walls 611 are flush with the outer surface of the casing of device 60. Hence, there is no unevenness between the casing and walls 611.

The stand is preferentially made of plastic and is, for example, obtained by one-piece plastic injection.

Depth d1 of the base 610 sitting on the floor is, for example, equal to 170 mm for a 26″ screen 10. More generally, the parts of the base 610 that are respectively located in front of and behind the walls 611 each have depth d5 and d′5 preferentially greater than 4 cm, and even more preferentially greater than 6 cm. Hence, the stability of the display device 60 is ensured when it is set on a noticeably horizontal plane. Preferentially, the display system 6 must remain stable when sitting on a plane inclined by 11° forward or backward. In other words, depths d5 and d′5 are such that the centre of gravity, G, 1001, of system 6 is preferentially between two vertical planes that pass respectively through the extremities corresponding to the front and rear edges of base 610 when the device is sitting on a noticeably horizontal plane and has an angle of inclination less than or equal to 11° forward or backward of the device 1.

Hollow area 616 in base 610 has a depth greater than or equal to height d3 of the recesses 605 to 607. Height d3 is, for example, equal to 50 mm and more generally is between 30 and 60 mm for display systems 6 dedicated to television sets with a screen diagonal between 20″ to 37″.

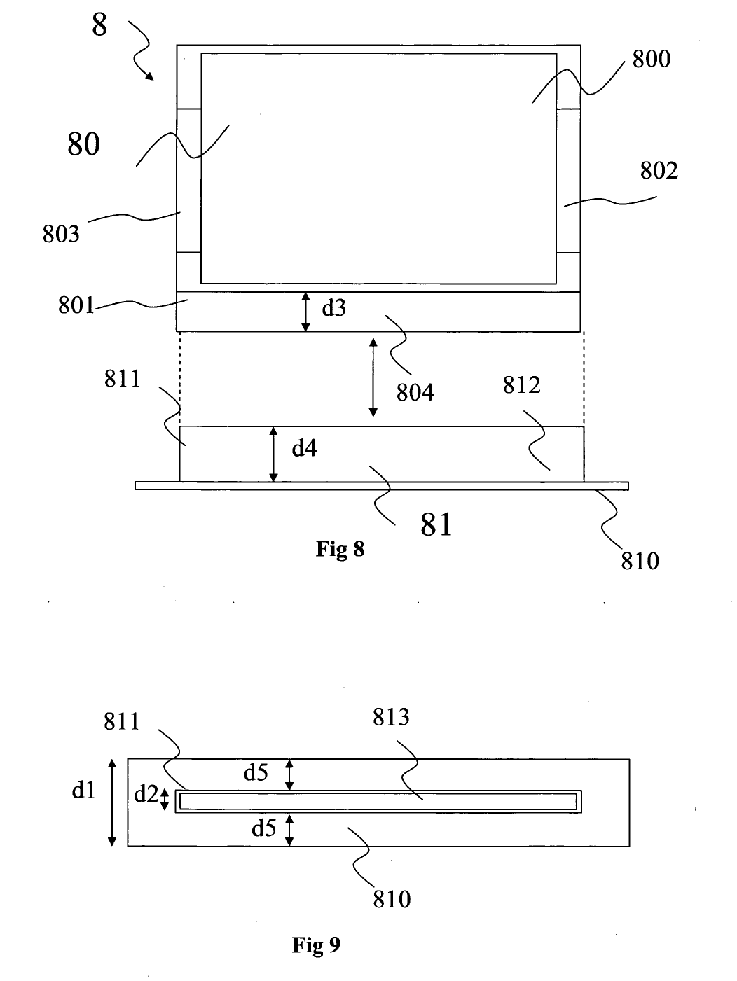

FIGS. 8 and 9 illustrate diagrammatically a front view and a top view of display system 8 according to a variant embodiment of the invention.

The front of the display system 8 comprises:
a display device 80 comprising a flat screen 800, a casing 807 and two side loudspeakers 802 and 803, and
a hollow stand 81 designed to accommodate the display device 80.

The flat screen 80 is, for example, an LCD screen or a plasma-type screen.

When display system 8 is sitting on a noticeably horizontal plane, the display device 80 is inserted in the stand 81, which maintains the display device in a noticeably vertical position, and more generally in a position of comfort, allowing a spectator located opposite the screen to have a good view.

The stand 81 comprises a base 810, whose noticeably flat lower surface is designed to sit on a noticeably horizontal floor, and noticeably vertical walls 811 designed to hold the display device when it is inserted in the stand.

The walls 811 comprise:
cut-outs on the back face that allow the rear parts of the display device to be inserted (power supply, inputs/outputs), and
side and front supports 813.

Preferentially, the outer surfaces of the walls 811 and of the display device 80 are contiguous and tangent; in other words, the casing of the display device 80 comprises a recess 801, whose depth is preferentially greater than or equal to (and even more preferentially, equal to) the thickness of walls 811, such that walls 811 are flush with the outer surface of the casing of the device 80. Hence, there is no unevenness between the casing and walls 811.

The stand is preferentially made of plastic and is, for example, obtained by one-piece plastic injection.

Width d1 of the base 810 sitting on the floor is, for example, equal to 170 mm for a 26″ screen 80. More generally, the parts of the base 810 that are respectively located in front of and behind the walls 811 each have a depth d5 preferentially greater than 4 cm and even more preferentially greater than 6 cm. Hence, the stability of the display device 80 is ensured when it is set on a noticeably horizontal plane.

The hollow area 813 in the base 810 has a depth d4 greater than or equal to height d3 of the recess 801.

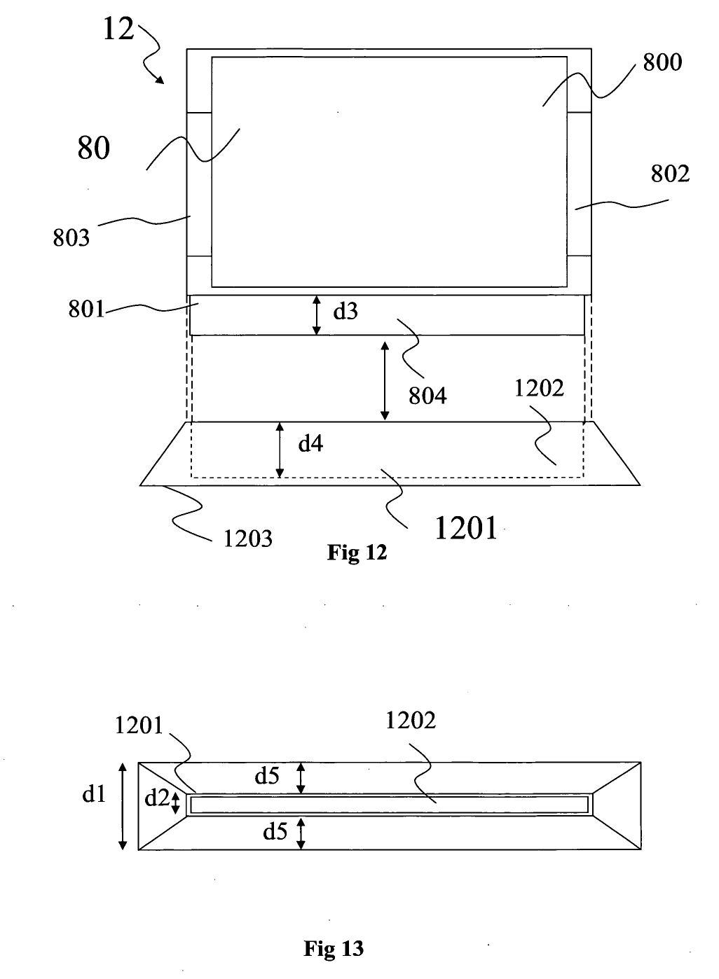

FIGS. 12 and 13 illustrate diagrammatically a front view and a top view of display system 12 according to a variant embodiment of the invention.

The display system 12 comprises:
a display device 80 similar to the device illustrated in FIG. 8, and with the same references, and
a hollow stand 1201 designed to accommodate the display device 80.

The stand 1201 comprises a base 1203, which is designed to sit on a noticeably horizontal floor, and a hollow area 1201 whose internal walls are noticeably vertical and whose depth d4 is greater than or equal to height d3 of the recess 801. The hollow area 1201 is designed to hold the display device 80 when said device is inserted into the stand. The sides of stand 1201 are oblique, which notably enables its rigidity to be increased. This also allows for increased weight, which improves the stability of the device by lowering the centre of gravity of the whole.

Display device 12 comprises a recess 801 of a depth preferentially greater than or equal to (and even more preferentially, equal to) the thickness of the upper part of stand 1201, such that the outer surface of the stand 1201 is flush with display device 80. Hence, the stand 1201 and the device 80 are contiguous, and there is no unevenness between the two elements.

According to one variant, the stand has an outer surface whose upper portion is noticeably vertical and which flares out gradually or in stages. Hence, the stand and the device are contiguous and tangent.

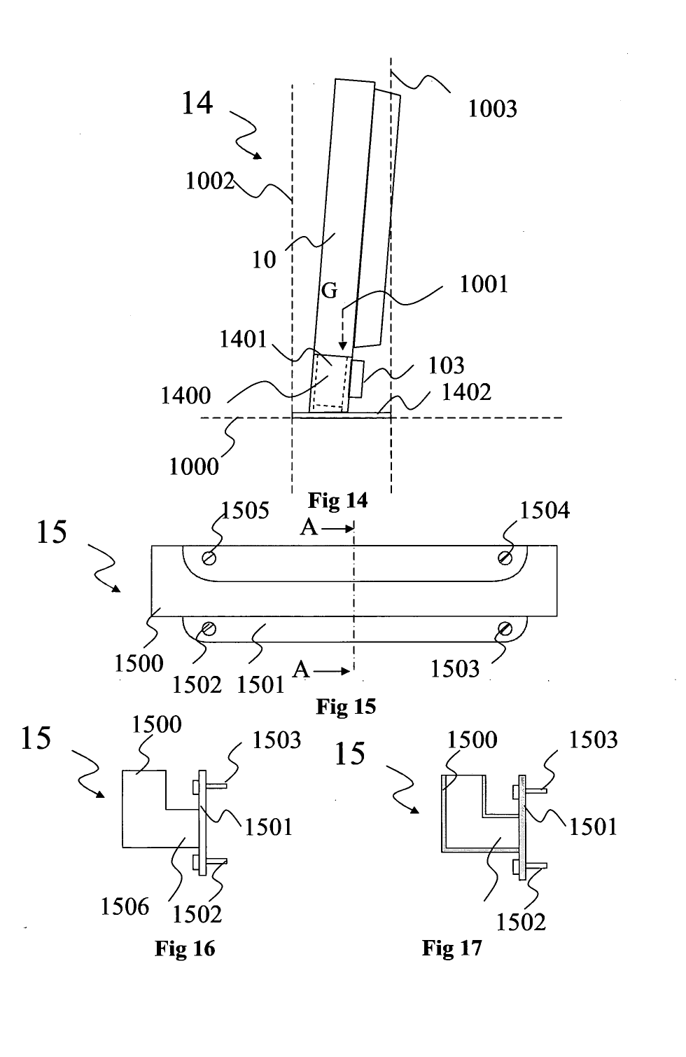

FIG. 14 diagrammatically illustrates a side view of the display device 14 according to a preferred embodiment of the invention.

The display system 12 comprises:
a display device 10 similar to the device illustrated in FIG. 1, and with the same references, and
a hollow stand 1400 designed to accommodate the display device 10.

The stand 1400 comprises a base 1402 designed to sit on a noticeably horizontal floor and hollow area 1401 whose internal walls are slightly inclined backward, preferentially at an angle less than or equal to 3°, typically between 1.5° and 3°. The depth of the hollow area 1401 is greater than or equal to the height of the recess of the device 10. The hollow area 1401 is designed to hold the display device 10 in a position slightly inclined backward to ease viewing for spectators and/or reduce the depth of the base located in front of the device 10 when this device is inserted in the stand. The display device 10 comprises the recesses 105 and 106, of a depth preferentially greater than or equal to (and even more preferentially, equal to) the thickness of the upper part of the stand, such that the walls 110 are flush with the outer surface of the stand 1400. Hence, the stand 1400 and the device 10 are contiguous and tangent, and there is no unevenness between the two elements.

FIGS. 15 to 17 illustrate diagrammatically a front view, a side view and cross-section AA, according to a side view of a stand according to a variant embodiment of the invention.

The display system according to FIGS. 15 to 17 comprises:
a display device 10 similar to the device illustrated in FIG. 1 (and not shown in FIGS. 15 to 17), and
a hollow stand 15 designed to accommodate the display device 10.

The display device 10 is inserted in stand 15, which maintains the display device in a noticeably vertical position (that is with a screen whose front plane makes an angle less than or equal to 11° with the vertical), and more generally in a position of comfort, allowing a spectator located opposite the screen to have a good view.

The stand comprises a base 1506, walls 110 and a wall mount 1501. The base 1506 is connected to the wall mount, which comprises a noticeably flat side face designed to be mounted on a noticeably vertical wall (meaning that it makes an angle less than or equal to 11° with a vertical plane). According to variant embodiments, the walls can be tilted forward to allow for a high position, the screen itself being tilted forward. According to another variant, the walls are tilted slightly backward to allow for positioning near the floor, the screen itself being tilted backward.

The wall mount comprises means for attaching it to a wall (for example, holes allowing screws 1502 to 1505 to pass through), the wall mount being screwed to the wall or sliding between the wall and the screw heads (holes to allow screw heads to fit through, with a slot on the upper part that is large enough to accommodate the body of the screws but not the screw heads). The internal and external surfaces of the walls 1500 are noticeably vertical, the walls 1500 forming a hollow space and being designed to hold display device 10 when this device is inserted in the stand. The thickness of the walls is preferentially less than or equal to 3 mm. The thickness of the wall mount is preferentially between 3 and 7 mm. The base is preferentially, but not necessarily, hollow.

Hence, the display device provides relative flexibility of use as the user can easily suspend the screen on a wall (embodiment with stand including wall mount) and/or set it on a noticeably horizontal surface (according to the embodiments of the stand designed to sit on a floor). In addition, the display device can be easily transported with or without the stand (this stand can be left in place or, conversely, moved).

Naturally, the invention is not limited to the embodiments previously described.

In particular, a person skilled in the art will be able to create a stand made of anything other than plastic (for example, metal).

Furthermore, the invention is not limited to attaching display devices with LCD-type screens, but relates to all flat screen devices that notably have an overall depth less than or equal to 100 mm, the depth of the part being inserted in the corresponding stand being preferentially less than or equal to 50 mm. In particular, the invention relates to a flat-screen, monitor-type viewing system with a relatively small depth (for example equal to 12 mm or even 8 mm). Hence, for a 15″ screen, the depth of the corresponding stand, in front of and behind the vertical walls is, for example, between 40 and 45 mm. This is particularly advantageous for viewing systems dedicated to laptop computers as transport is facilitated (reduced cumbersomeness).

The invention also relates to display systems whose stands possess walls inclined backward in relation to a plane perpendicular to their bases, preferentially at an angle less than or equal to 3° (for example between 1.5° and 3). According to such an embodiment, the depth of the base in front of the walls may be reduced (indeed, in this case, the system's centre of gravity is moved backward) to satisfy the condition of stability of the system sitting on a noticeably horizontal floor and preferentially inclined according to an angle less than or equal to a horizontal plane.

The invention concerns systems with a contiguous and tangent display device and associated stand. It also relates to systems whose display device and associated stand are not tangent (as illustrated in FIG. 12), or even non-contiguous. Indeed, the invention also relates to systems with a display device without recesses in the lower part. According to this variant, the display device is not specific and the stand is suitable to hold such a device.

1. Display system comprising a flat-screen display device and a support for the said display device,
wherein said support forms a removable stand designed to accommodate the said display device.

2. System according to claim 1, wherein the said stand comprises a base designed to hold the said screen in a noticeably vertical position when the system is set on a noticeably horizontal plane.

3. System according to claim 1, wherein the said stand comprises a base and an associated wall mount, the said base and the said wall mount being designed to hold the screen in a noticeably vertical position when the said wall mount is mounted on a noticeably vertical plane.

4. System according to claim 1, wherein the said stand comprises noticeably vertical walls in its hollow part when the said system is set on a noticeably horizontal plane, the said display device being inserted between the said walls.

5. System according to claim 1, wherein the said stand comprises noticeably vertical outer walls.

6. System according to claim 1, wherein the said stand comprises a base with a lower face and an upper face, the upper face being noticeably parallel to the lower face.

7. System according to claim 1, wherein the said display device comprises recesses in its lower part, designed to be inserted in the stand.

8. System according to claim 7, wherein the outer walls of the stand and of the display device are contiguous.

9. System according to claim 8, wherein the outer walls of the stand and of the display device are tangent.

10. System according to claim 1, wherein the said base is ballasted.

11. Stand to support a display device with a flat-screen when it is sitting on a noticeably horizontal floor, the said stand and the said display device forming the display system, the stand being removable and designed to accommodate the said display device, the stand comprising a base designed to hold the flat screen in a noticeably vertical position when the system is set on a noticeably horizontal plane.

12. Stand to support a display device with a flat-screen when it is suspended on a noticeably vertical plane, the stand comprising a base and an associated wall mount, the said base and the said wall mount being designed to hold the flat-screen in a noticeably vertical position when the said wall mount is mounted on a noticeably vertical plane.
